(19) United States
(12) Patent Application Publication
(10) Pub. No.: US 2011/0183054 A1
(43) Pub. Date: Jul. 28, 2011

(54) PROCESS FOR THE PREPARATION OF A MOIST PROTEIN BIOMASS AND ITS USE

(75) Inventors: Claudia Pickardt, Berlin (DE); Christian Zacherl, Freising (DE); Peter Eisner, Freising (DE); Katrin Hasenkopf, Freising (DE)

(73) Assignee: Fraunhofer-Gesellschaft zur Foerderung der angewandten Forschung e.V., Muenchen (DE)

(21) Appl. No.: 12/737,229

(22) PCT Filed: Jun. 29, 2009
(86) PCT No.: PCT/DE2009/000918

§ 371 Date: Apr. 1, 2011

(30) Foreign Application Priority Data
Jun. 30, 2008 (DE) 10 2008 030 325.9
Oct. 28, 2008 (DE) 10 2008 053 587.7

(51) Int. Cl. A23J 1/14

(52) U.S. Cl. 426/431

(57) ABSTRACT

A process is described for preparing a plant protein preparation for a foodstuff. In the process, a proteinaceous vegetable raw material is introduced into a salty, aqueous extractant for the extraction of proteins, whereby a salty plant protein solution is obtained. The proteins are precipitated by lowering the temperature and/or the ionic strength of the plant protein solution and separated from the aqueous extractant as a moist protein-rich substance. The process is distinguished by the fact that the plant protein solution, before or after the protein precipitation step, or the protein-rich substance, before or after introduction into the foodstuff and before finishing the foodstuff, is heated to a temperature of ≧45° C. and held at this temperature for a period of time, the period of time and the temperature being chosen so that the use properties and processing properties of the protein-rich substance are not altered by this step. Due to this pre-heating operation, the plant protein preparation causes a lower degree of undesired off-flavors upon heating of the foodstuff in which it has been processed. Also described is a method for producing a plant protein preparation in the form of a moist protein mass for improving the texture of foodstuffs with improved organoleptic properties.

### TECHNICAL FIELD

The invention relates to a method for producing a plant protein preparation in the form of a moist protein mass for improving the texture of foodstuffs with improved organoleptic properties.

### PRIOR ART

The use of plant proteins in foodstuffs is becoming increasingly important. In addition to their good eco-efficiency and their low production costs, a range of plant proteins are characterised by a health-promoting effect. Furthermore, protein preparations are added to foodstuffs as functional additives.

Commercially available plant protein preparations have good emulsifying and foaming properties, high water binding capacity and high gel strength. The addition of animal and plant protein preparations for the targeted improvement of the texture of foodstuffs is also known. Known protein preparations for improving texture and for producing a smooth and creamy feeling can be obtained by various methods, spherical and/or very small particles usually being produced.

Owing to the good transport and storage properties, these products are dried to form powders and must be rehydrated for use in foodstuffs, for which efficient metering and mixing devices are however necessary. A further disadvantage of the dried products lies in the possible formation of particle agglomerations during drying or during mixing into the foodstuff, which can lead to a sandy impression in the mouth. An uneven distribution of the protein particles in the product can result in the loss of the smooth and creamy properties.

WO 2008/000213 describes a method for producing the plant protein preparation, in which plant proteins are dissolved or suspended in a solvent. An accumulation of the proteins to each other takes place due to a simultaneous reduction of the ion concentration and temperature which takes place in a short time. The protein particles which form from the individual proteins precipitate out of the solution. Following the precipitation of the protein particles, they are separated from the solvent surrounding them by a mechanical separation method. The protein mass obtained in the process can be used as a protein preparation in foodstuffs.

However, undesirable plant-like off-flavours can occur during subsequent heating of the foodstuff, which are described as bean-like or grass-like, bitter and “green” among other things, when this protein mass is used as a fat substitute product in foodstuffs. In particular the use of protein-containing starting material consisting of legumes, in particular lupins, is difficult with regard to the sensory properties of the end product, as these plants have a high content of bitter-tasting compounds as well as of substances which taste grass-like, bean-like or green. These off-flavours can in particular occur if the foodstuff is heated to temperatures of more than 60° C. for the purposes of preparation.

The object of the present invention is therefore to specify a method for producing a plant protein preparation which causes a lower level of undesirable off-flavours following heating of the foodstuff in which it has been processed.

### DESCRIPTION OF THE INVENTION

The object is achieved with the method according to Patent Claim 1. Advantageous configurations of the method form the subject matter of the dependent patent claims or can be found in the description below.

The protein preparation according to the invention, also referred to as protein mass below, which is preferably used as a fat substitute product, has in contrast to conventional fat substitutes a water content of more than 30% by weight and is produced without drying. It is present as an aqueous mixture of protein and accompanying plant substances in a homogeneous mass which can be used in a moist form for substituting fat in foodstuffs.

The above-described unpleasant flavour impression is reduced in the proposed method in that the plant protein solution, before or after the step of precipitating the proteins, or the protein-rich mass, before or after introduction into the foodstuff and before finishing the foodstuff, is heated to a temperature of 45° C. and held at this temperature for a period of time. The period of time and the temperature are selected such that the use and processing properties of the protein-rich mass are not changed by this step. The use properties mean in this case the smooth feeling on consuming the protein-rich mass, the processing properties mean the pasty consistency and smooth texture. This is preferably achieved by selecting a period of time and a temperature at which an irreversible denaturing by heat of the proteins is largely avoided, that is, at which a proportion of ≧80% of the proteins in the protein-rich mass are not irreversibly denatured.

This measure is traced back to the surprising finding of the inventor that the unpleasant flavour impression, which previously occurred when heating a foodstuff processed with the moist protein mass of the prior art described above, is perceived less intensively when the foodstuff is heated a second time. In the proposed method, therefore, the foodstuff with the mixed in protein mass is preheated once before finishing the foodstuff, that is, before it is prepared as an end product. Alternatively, the protein mass itself or the plant protein solution can also be correspondingly preheated during the production of the protein mass.

The protein preparation is obtained by precipitating proteins from salt-containing plant protein solutions by reducing the temperature and/or the ionic strength of the solution, whereby a protein-rich mass forms which is separated from the water.

To this end, the proteins are preferably extracted from a plant raw material with a salt solution in a ratio of 1:3-1:20 (raw material:salt solution), most preferably 1:5-1:10. This solution has a salt content of 0.5 to 10% by weight, preferably 2-4% by weight, of cooking salt (sodium chloride) or a comparable concentration of another salt and is preferably heated to a temperature of up to 30° C. or between 40 and 50° C. for extraction purposes. A temperature of 45° can be the above preheating step, that is, result in a clear reduction in the unpleasant flavour impression. Heating is however preferably carried out again later at a higher temperature.

Following the protein extraction, undissolved constituents of the raw material are separated by mechanical separation methods, for example centrifugation or filtration. To obtain the protein mass, the temperature and/or the salt content (ionic strength) of the plant protein solution is lowered by mixing the protein extract for example with salt-free or low-salt iced water in a ratio of 1:1 to 1:10 (protein extract:iced water), preferably 1:2-1:4. The protein mass is separated from the diluted solution by sedimentation or centrifugation. Further mechanical methods for concentrating and separating, for example filtration, are possible, sedimentation methods preferably being used. To precipitate out the proteins, the plant protein solution can also be mixed with salt-free or low-salt water in the above ratio without cooling. Just cooling the plant protein solution, preferably with iced water, is also possible. Furthermore, there is also the possibility of diluting the plant protein solution with salt-free or low-salt water first and then cooling it in order to precipitate the proteins.

The protein mass obtained with the method according to the invention typically has a protein content of approx. 30% by weight to 70% by weight, a water content of approximately 30% by weight to 70% by weight and has outstanding properties for lending a soft, smooth and creamy texture to foodstuffs. The protein content and the water content can be changed by changing the sedimentation conditions. A protein mass with a water content of 80% by weight and a protein content (N×6.25) in the dry mass of 80% by weight can be achieved by sedimentation for a period of 10 hours at 1° C. A centrifugation at 3000 g for 10 min results in the reduction of the water content in the protein mass to proportions below 60% by weight with a simultaneous increase in the protein content. The protein content can be increased by depletion of salts by diluting again with a cold, low-salt solvent and subsequent separation to values above 90% by weight in the dry mass. The product yield of the moist fat substitution protein mass is 20-150% in relation to the raw material mass depending on the raw material used and the degree of concentration, the yield of dry mass being between 20 and 80%.

The protein mass according to the invention which is obtained is characterised by a particular consistency compared to other products. The protein mass is a homogeneous mass with a viscous, partially gel-like consistency, which varies depending on the concentration and temperature, and has rheological properties like mayonnaise, honey or blancmange depending on the moisture content and temperature. No defined structures can be seen when examined under a microscope or under a scanning electron microscope. When consumed, the protein mass produces a full-bodied, creamy to pasty and smooth feeling in the mouth.

As the protein mass is not dried, it can be worked into a wide variety of foodstuffs in a pasty or highly viscous form, for example as a fat substitute. The foodstuffs are then provided with a soft, creamy texture so that some of the fat can be omitted from the recipe without a dry, rough impression being produced. This can have nutritional and physiological advantages. The protein mass is not at all or only poorly soluble in water owing to the described precipitation method with reduction of the temperature and/or ionic strength. However, it binds a certain amount of liquid and can to a limited extent be mixed with both water and fat to form a stable homogeneous mass. The water content can in particular be adjusted by the selection of the separation conditions by sedimentation. The water content in the finished foodstuff can be in the range from to 90% and the fat content from 0 to 60%, preferably between 1 and 10 to 30%. A maximum fat content of 60% would for example be given when used in a reduced-fat mayonnaise.

The protein mass according to the invention thereby has advantages compared to the pulverulent products available on the market for replacing fat in foodstuffs with regard to metering and manageability in that rehydration is not necessary. It has a particularly smooth and/or creamy consistency and homogeneity compared to particulate pulverulent preparations. A further advantage is the cost saving due to the omission of the drying stage.

The protein mass according to the invention has a neutral to slightly salty taste in the raw state. This can be removed by one or a plurality of washing steps as described above.

Particularly good depletion of the unpleasant flavours is achieved if the foodstuff with the mixed in protein mass is heated to a temperature 45° C., preferably 55° C., and held at this temperature for a holding time of several minutes, for example 10-60 min. At these temperatures denaturing by heat of the fat substitute protein is avoided and the particularly soft, creamy and smooth impression in the mouth is obtained, depending on the selected residence time and raw material. Surprisingly, it was found that heating above 60° C. also takes place without loss of these properties if a correspondingly short heating time, depending on the temperature level, is not exceeded. For example, the off-flavours can also be changed during a short heating stage of 15-30 s at 72-75° C. in such a manner that they no longer become unpleasantly noticeable when the foodstuff is heated again. Heating at higher temperatures in a similar manner to known methods for the heat treatment of milk products is conceivable, for example heating at 85-90° C. for 1-20 s or at 130 to 140° C. for 0.1 to 30 s.

Particularly good results are also achieved if the protein mass is treated with heat before use in foodstuff. In one configuration, the protein mass is heated at a temperature of 55 to 65° C. and held at this temperature for a period of time. It is cooled to a temperature of 4-10° C. before use in foodstuff. In a further configuration, the protein mass can be worked directly into the foodstuff without cooling. The reduced viscosity, which simplifies mixing with the recipe constituents, has in this case proven particularly advantageous.

In a further configuration, the heating step is carried out before the step of protein precipitation in the extraction solution. To this end, the protein solution can also be diluted or concentrated. In a further configuration, the heating step can also be carried out after the protein precipitation, before the separation of the proteins out of the mixture takes place. In this case it is shown that the yield and the smooth texture of the separated protein preparation are not or only slightly adversely affected by the heating step, in particular if the temperatures do not exceed 75° C.

The preheating stages carried out in the proposed method are suitable for preventing unpleasant flavour impressions from forming and becoming noticeable in the foodstuff on reheating, which is often necessary when using the foodstuff according to its intended use, and at the same time obtaining the silky texture of the protein mass, it being possible to apply the heat to the raw protein mass or during its production or processing.

Heating to temperatures above 100° C. under pressure can be used if the time of the treatment is limited to a few seconds to minutes. For example, a temperature of 130-150° C. for 0.1 to no more than 30 s, preferably for 2-10 s, can be used. Heating to 120° C. is possible for a time of 10 s to no more than 3 minutes, depending on the degree of dilution of the protein mass, the flavour stabilisation being more effective at lower temperatures and longer times.

The protein mass, or preferably the protein solution, is preferably heated during production to 55° C. to 75° C. for 40 min to 1 min or to 75° C. to 85° C. for 60 s-1 s, shorter residence times preferably being combined with higher temperatures. With a particularly high concentration of unpleasant flavour components, a longer treatment of 1-30 minutes at temperatures above 75° C. can also be necessary to stabilise them before further heating.

Carrying out the heating step before the precipitation or separation of the supernatant is particularly advantageous because flavourings are removed with the separated liquid which are transferred from the protein into the liquid during heating. At the same time the heat-sensitivity of the proteins is reduced with greater water content, so that the smooth texture of the protein preparation is unaffected even at higher temperatures of up to 80° C.

The protein mass produced with the method according to the invention contains accompanying plant substances in a low concentration or in a concentration which has no effect on flavour after heating in such a manner that texture, taste and flavour impression are not affected by it in the planned use. Furthermore, the mass can thanks to the method contain traces of salts and sugars which however do not have an unpleasant effect depending on the use.

### Exemplary Embodiment

A simple exemplary embodiment for the production of the product according to the invention is described below:
1. Stirring comminuted, protein-containing plant raw material (for example lupin flakes or lupin flour) into H₂O with a salt content of 2% by weight NaCl at a temperature of 40° C. Ratio of plant raw material to extractant 1:10.
2. Adjusting the pH value to 6.8; stirring at 100 rpm for 20 minutes at 40° C.
3. Centrifugation for 5 minutes at 20,000 g and discarding the sediment.
4. Heating the extract to 55° C. for 30 min.
5. Cooling the extract to 40° C. and transferring the extract (temperature 40° C.) with a hose pump by injecting into salt-free water (temperature 3° C.) Ratio of extract to salt-free water 1:3.
6. Precipitating for 10 hours at a temperature of 3° C.
7. Drawing off the clear supernatant.
8. Centrifugation of the precipitated sediment for 5 minutes at 20,000 g for further dehydration.
9. Discarding the supernatant.
10. Precipitate: product according to the invention.

1-17. (canceled)

18. A method for producing a plant protein preparation for a foodstuff comprising
(a) introducing a protein-containing plant raw material for extraction of proteins therefrom into an aqueous extractant which has a salt content, to obtain a salt-containing plant protein solution,
(b) precipitating the proteins out of the salt-containing plant protein solution by lowering either temperature, or ionic strength, or temperature and ionic strength, of the plant protein, and
(c) separating the proteins precipitated in (b) as a moist, protein-rich mass from the aqueous extractant,
wherein the salt-containing plant protein solution before or after the precipitating of the proteins in (b), or the protein-rich mass of (c) before or after introduction into a foodstuff and before finishing the foodstuff, is heated to a temperature of ≧45° C. and held at such temperature for a period of time, the period of time and the temperature being selected such that use and processing properties of the protein-rich mass are not changed thereby.

19. The method according to claim 18, wherein the period of time and the temperature are selected so that an irreversible denaturing by heat of the proteins is substantially avoided.

20. The method according to claim 18, wherein the foodstuff including the protein-rich mass is heated to a temperature of ≧55° C. and held at such temperature for a plurality of minutes.

21. The method according to claim 18, wherein the protein-rich mass or the plant protein solution is heated to a temperature of 55° C. to 75° C. and held at such temperature for the period of time selected.

22. The method according to claim 21, wherein the protein-rich mass or the plant protein solution is held at the temperature for a period of 40 min. to 1 min.

23. The method according to claim 18, wherein the protein-rich mass or the plant protein solution is heated to a temperature of 75° C. to 85° C. and held at such temperature for a period of 60 sec. to 1 sec.

24. The method according to claim 18, wherein the protein-rich mass or the plant protein solution is heated to a temperature of 85° C. to 140° C. and held at such temperature for a period of 1 sec. to 0.1 sec.

25. The method according to claim 18, wherein the introducing of the protein-containing plant raw material into the aqueous extractant takes place in a ratio of 1:3 to 1:20.

26. The method according to claim 18, wherein the introducing of the protein-containing plant raw material into the aqueous extractant takes place in a ratio of 1:5 to 1:10.

27. The method according to claim 25, wherein the salt content of the aqueous extractant is 0.5 to 10% by weight.

28. The method according to claim 26, wherein the salt content of the aqueous extractant is 2 to 4% by weight.

29. The method according to claim 25, wherein the aqueous extractant for obtaining the proteins is heated to a temperature of up to 30° C. or between 40° C. and 50° C.

30. The method according to claim 26, wherein the aqueous extractant for obtaining the proteins is heated to a temperature of up to 30° C. or between 40° C. and 50° C.

31. The method according to claim 27, wherein the aqueous extractant for obtaining the proteins is heated to a temperature of up to 30° C. or between 40° C. and 50° C.

32. The method according to claim 28, wherein the aqueous extractant for obtaining the proteins is heated to a temperature of up to 30° C. or between 40° C. and 50° C.

33. The method of claim 18, wherein undissolved constituents of the raw material are separated from the plant protein solution by a mechanical separation method.

34. The method according to claim 18, wherein the plant protein solution is mixed with salt-free water or low-salt water in a ratio of 1:1 to 1:10 to precipitate the proteins.

35. The method according to claim 18, wherein the plant protein solution is mixed with salt-free water or low-salt water in a ratio of 1:2 to 1:4 to precipitate the proteins.

36. The method according to claim 18, wherein the plant protein solution is cooled to precipitate the protein.

37. The method according to claim 36, wherein the plant protein solution is mixed with iced water for cooling.

38. The method according to claim 18, wherein the plant protein solution is diluted with salt-free water or low-salt water and then cooled to precipitate the proteins.

39. The method according to claim 18, wherein the plant protein solution is mixed with salt-free iced water or low-salt iced water in a ratio of 1:1 to 1:10 to precipitate the proteins.

40. The method according to claim 18, wherein the plant protein solution is mixed with salt-free water or low-salt water in a ratio of 1:2 to 1:4 to precipitate the proteins.

41. The method according to claim 18, wherein the protein-rich mass is separated by sedimentation or centrifugation from the aqueous extractant.
